(19) United States
(12) Patent Application Publication
(10) Pub. No.: US 2002/0010786 A1
(43) Pub. Date: Jan. 24, 2002

(54) Data transmitting apparatus and method

(76) Inventors: Axel Brandes, Adenstedt (DE); Ralph Behrens, Hildesheim (DE)

Correspondence Address: Samuels, Gauthier & Stevens LLP, 225 Franklin Street, Suite 3300, Boston, MA, 02110, US

(21) Appl. No.: 09/867,772

(22) Filed: May 29, 2001

(30) Foreign Application Priority Data
May 26, 2000 (DE) 100 25 929.4

(51) Int. Cl. G06F 15/16

(52) U.S. Cl. 709/229; 713/201

(57) ABSTRACT

Data transmitted between a server and a client with a data processing module and with a firewall, is investigated by the firewall for security-specific aspects. The firewall controls the data traffic such that further processing and/or forwarding of unallowed data to and/or from at least one of the data processing modules.

### BACKGROUND OF THE INVENTION

The present invention relates to the field of server-client systems, and in particular to a system that includes a client having a firewall and communicates with the server via a wireless communications channel.

When a direct connection from a client computing device to a server is established, there is no checking of the transmitted data. As a result, free access from the client to the server, and free access from the server to the client are both possible.

If the server is within a public network, then in principle every subscriber to the public network as well as the server itself has access to the client. Therefore, unauthorized access to the client is also possible. In the past, it has frequently become apparent what devastating effects and consequences such unauthorized access can have. To restrict access, firewalls are often used to provide a single point of entry where a defense can be implemented, allowing access to resources on the Internet, while providing controlled access to the client.

Between the client and the server a connection is established via a firewall, which checks the transmitted data and prevents a direct and secure connection between the client and the server. A disadvantage of prior art systems that include a firewall is that the constant checking of the transmitted data does not allow a direct and secure connection between the client and the server.

Therefore, there is a need for a data transmission method and apparatus in which a direct connection between the client and the server exists, and transmitted data can be checked in accordance with security-specific aspects to prevent unauthorized access.

### SUMMARY OF THE INVENTION

Data traffic takes place between a server and a client, via a firewall, such that the firewall prevents further processing and/or forwarding of unallowed data to and/or from at least one of the data processing modules.

Data traffic uninfluenced by the firewall takes place between the server and at least one second data processing module. This is especially appropriate when information is to be exchanged that does not contain security-relevant data and, on the basis of which, no independent processes are initiated. Nevertheless, it continues to be assured that the data flow between the first processing module and the server is checked in accordance with security-specific aspects and that the transfer is prohibited in certain circumstances.

Another modification of the invention specifies that data traffic influenced by the firewall takes place between at least one second data processing module, from which data traffic to the server takes place without influence from the firewall and a first data processing module, from which data traffic to the server takes place under the influence of the firewall. This connection assures rapid data exchange between individual secure and insecure data processing modules, without thereby giving up security-specific aspects. The firewall checks data which are to be processed further, regardless whether they have been transmitted from the server via a direct non-secure data channel or a secure data channel.

Data furnished by a data medium are conducted to at least a first data processing module. The firewall can prevent data which are furnished by a data medium but which are prohibited from being further processed by and/or forwarded to the first data processing module.

The firewall is preferably connected between a receiving module and at least one data processing module inside the client. Standard-conforming and commercial programs may be used to connect the client to the server. As a result, development costs can be saved when compared to a special client-server connection, which may require consultation with the server operator or the service provider.

At least one second data processing module is connected to the receiving module, and thus unhindered data transfer is possible to this second data processing module. Transfers in connection with which no security-specific aspects need to be considered can be handled by this second data processing module.

The second data processing module is connected to the firewall. In this way, secure data transport is possible between the first and the second data processing module. Unauthorized transfer from the server via the second data processing module to the first data processing module is not possible.

At least one first data processing module is connected to a data medium. In addition, in one embodiment, the firewall is connected between the first data processing module and the data medium.

An especially advantageous modification of the invention specifies that the receiving module is simultaneously a transmission module. On the one hand, this permits the usually desirable correspondence with another client connected to the server and, on the other hand, makes possible the retrieval of information from the server.

The server may be a network server of a public network. The method and apparatus of the present invention consequently specify that the system not only satisfies the security-relevant aspects of a limited (local) network, but also those of a publicly accessible network. The specified solution permits, for example, a secure connection to a public server (e.g., to do banking business) without having to give up checking the transmitted data. Furthermore, if in the future new transmission networks are developed and used, the expense for adapting the proposed solution remains quite minimal, since no knowledge of the transmission technique itself is necessary. The principle of this proposed data transmission system is therefore universally applicable. Thus, for example a connection to any Internet server is also possible.

In a preferred embodiment, the second data processing module includes a browser client. The browser client can be a special type for mobile networks (e.g., a WAP browser) and, in the future also a full-featured Internet browser (e.g., Netscape Communicator or Microsoft Internet Explorer type browsers).

The first data processing module includes an audio unit and/or a video unit. The audio unit may contain, for example, functions such as a tuner, amplifier, or an equalizer. A video unit integrated into the system can be used as a television or as a picture telephone with a connected camera. The inventive system thus permits any data traffic and especially interactive data traffic.

The client may be part of a mobile unit.

The first data processing module may include a navigation unit. The navigation unit receives position data and routes calculated on the server through its connection to the public network, and can process the data. For example, a freight-forwarding business can in this way inform its drivers about new jobs and routes.

The mobile unit may be a motor vehicle such as a car or truck.

The first data processing module may include a telematic application. The telematic application can include telematic services such as dynamic traffic information (VINFO), traffic-jam reports, route recommendations, emergency services, parking and traffic guide information, etc. These applications and services are sensitive to the data that are being processed. For this reason, these data must be checked for the correctness of their content before they are transmitted to or processed by the telematic application, since syntactically correct data with erroneous semantics can disturb the function of the telematic application and thus the function of the particular automobile.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 is a block diagram illustration of a first prior art data transmission system;

FIG. 2 is a block diagram illustration of a second prior art data transmission system;

FIG. 3 is a block diagram illustration of a data transmission system according to the present invention;

FIG. 4 pictorially illustrates data flow in the firewall of the data transmission system of FIG. 3;

FIG. 5 pictorially illustrates various data flow scenarios in the firewall of the data transmission system of FIG. 3; and

FIG. 6 pictorially illustrates a data flow when requesting an Internet page with telematic (or audio) data in the transmission system of FIG. 3.

### DETAILED DESCRIPTION OF THE INVENTION

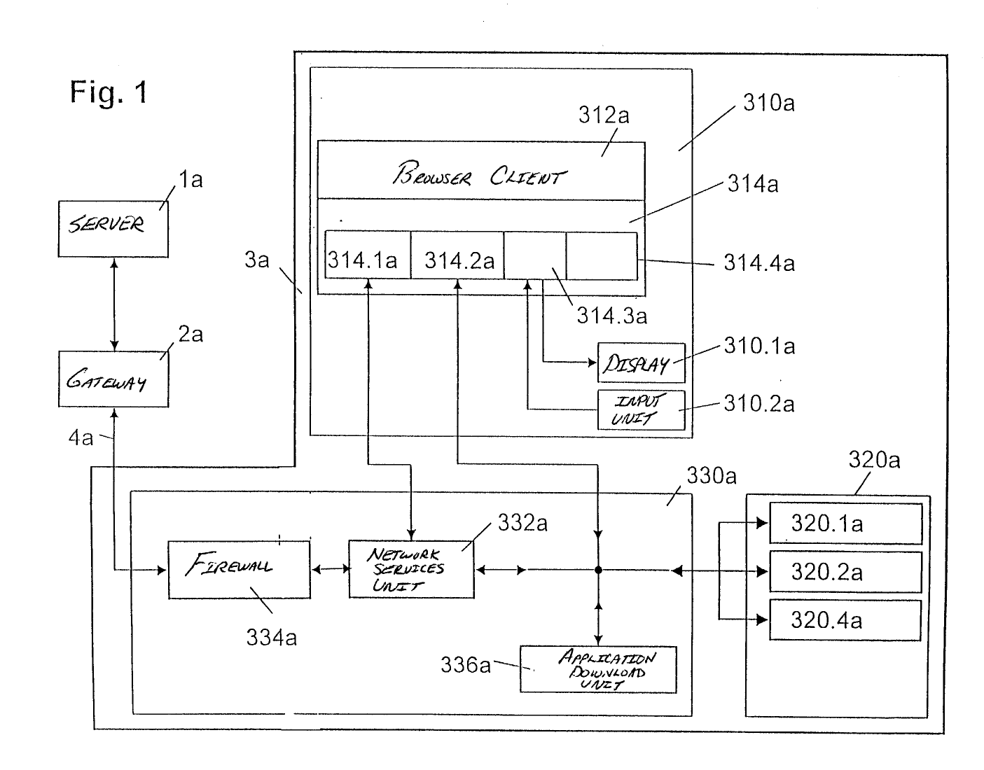

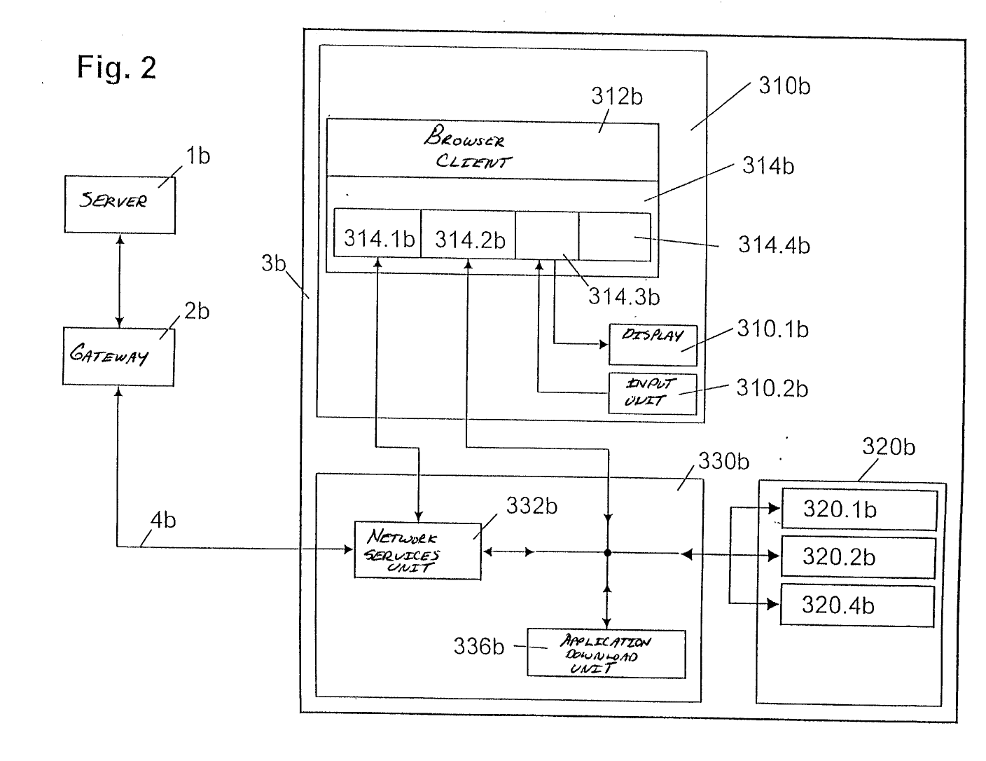

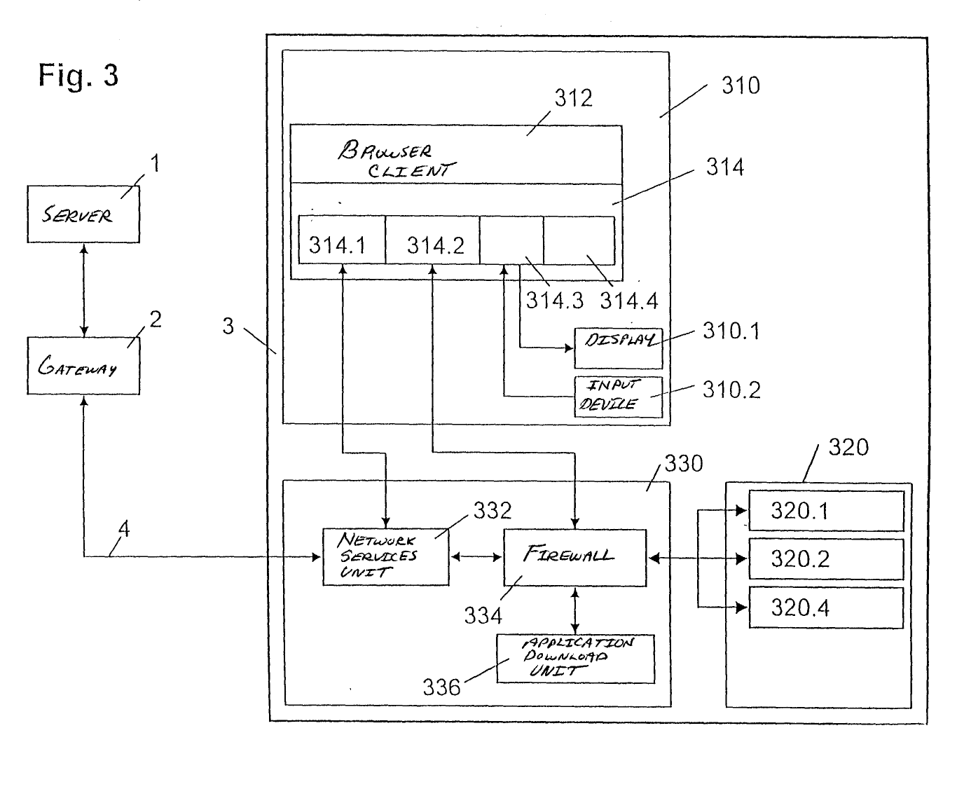

FIG. 3 illustrates a data transmission system according to the present invention. To clarify how this inventive data transmission system differs from those of the prior art, FIGS. 1 and 2 illustrate prior art data transmission systems. In one embodiment, the data transmission systems of FIGS. 1 to 3 illustrate the connection of a motor vehicle to a public network.

The data transmission system of FIG. 2 does not include a firewall, and there is no checking of the transmitted data. The system is thus based essentially on a server 1b and a client 3b. The client 3b includes a main unit 310b, various end devices 320b, and a communication manager 330b. The main unit 310b includes a browser client 312b that contains control logic, various functional units 314b, which service the browser client 312b with various device functionalities, a display unit 310.1b, and an input unit 310.2b. The display unit 310.1b and the input unit 310.2b are preferably components of an operating unit 314.3b. The functional units 314b also include a network access 314.1b, a unit for local services 314.2b, and other units, generically identified by the reference symbol 314.4b.

A communication manager 330b includes a network services unit 332b that provides network functions to the main unit 310. The communication manager 330b also includes an application download unit 336b that controls the downloading of firmware and/or software. The end devices 320b include a plurality of units such as a navigation unit 320.1b, an audio unit 320.2b and other conventional units 320.4b.

The server 1b is connected to the network services unit 332b via a gateway 2b. The server-client connection 4b is preferably a wireless communication link 4b. The network services unit 332b is connected to the network access unit 314.1b of the main unit 310. The network services unit 332b is also connected to the individual end devices 320b, such as for example the navigation unit 320.1b, the audio unit 320.2b, the other units 320.4b, and the local services unit 314.2b.

The data transmission system illustrated in FIG. 1 is based on a protected data transfer between a client and a server. The system illustrated in FIG. 1 is similar to the system illustrated in FIG. 2, however the communications unit manager includes a firewall 334a. The system illustrated in FIG. 2 is again based on a server 1a and a client 3a. The client 3a includes a main unit 310a, various end devices 320a, and a communication manager 330a.

The main unit 310a again includes a browser client 312a that contains control logic, various functional units 314a, which service the browser client 312a with various device functionalities, a display unit 310.1a, and an input unit 310.2a. The display unit 310.1a and the input unit 310.2a are the essential components of an operating unit 314.3a. The functional units 314a include a network access 314.1a, a unit for local services 314.2a, the operating unit 314.3a, and possible other units 314.4. The firewall 334a is connected between the gateway 2a and the unit for network services 332a.

FIG. 3 is a block diagram illustration of a data transmission system according to the present invention. The system is based on a server 1 and a client 3. The client 3 includes a main unit 310, various end devices 320a and a communication manger 330.

The main unit 310 includes a browser client 312 that contains control logic and various functional units 314, which service the browser client 312 with various device functionalities. The main unit 310 also includes a display unit 310.1, and an input unit 310.2.

The display unit 310.1 and the input unit 310.2 are components of an operating unit 314.3. The functional units 314 include a network access 314.1, a unit for local services 314.2, the already-mentioned operating unit 314.3, and possible other units 314.4.

The data transmission system of FIG. 3, like the data transmission system of FIG. 1, has a firewall 334. However, this firewall 334 is not connected between the gateway 2 and the network services unit 332, as is the case in FIG. 1, but between the network services unit 332 and the individual end devices 320. Furthermore, the firewall 334 is connected to the application download unit 336 as well as to the local services unit 314.2. The network services unit 332, the firewall 334, and the application download unit 336 are preferably components of the communication manager 330.

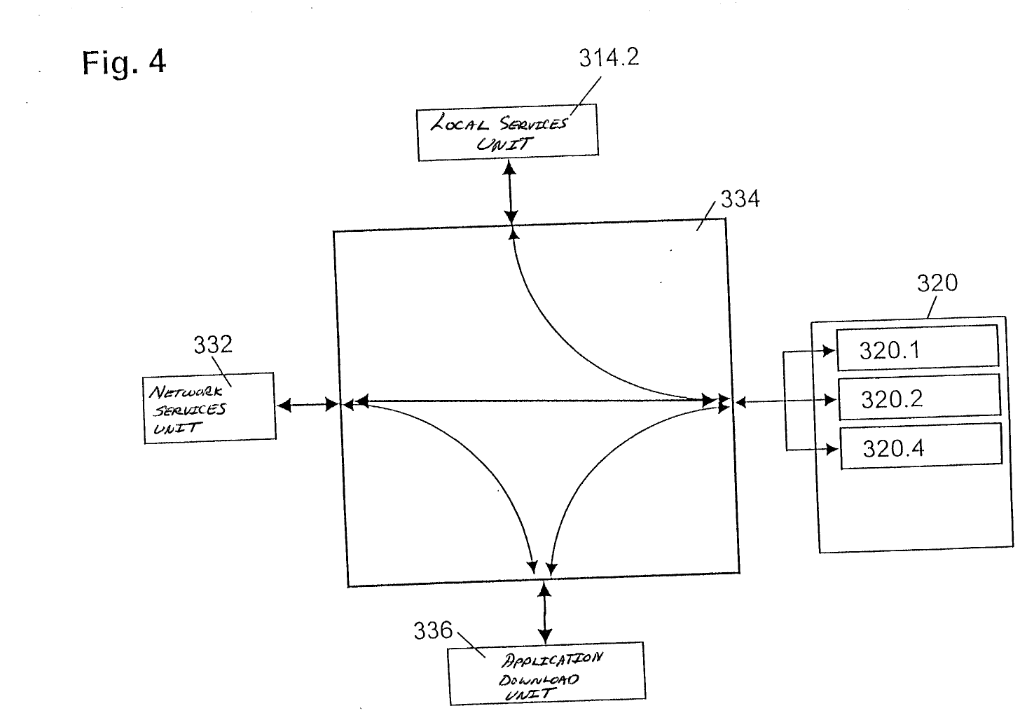

FIG. 4 is a pictorial illustration of data flow between various components and the firewall 334. The firewall 334 permits data flow between: (i) the local services unit 314.2 of the browser client 312 and the individual end devices 320, (ii) the application download unit 336 and these end devices 320, (iii) the application download unit 336 and the network services unit 332, and (iv) the network services unit 332 and the end devices 320.

To clarify the inventive principle, four examples of data transfer via the firewall 334 will be presented below. A first example demonstrates how a firmware update of the navigation unit 320.1b proceeds; a second example demonstrates retrieval of an Internet page; a third example describes a telematic application; and a fourth example describes the reception of an audio signal via Wireless Application Protocol (WAP).

### EXAMPLE #1

### Firmware Update of the Navigation Unit

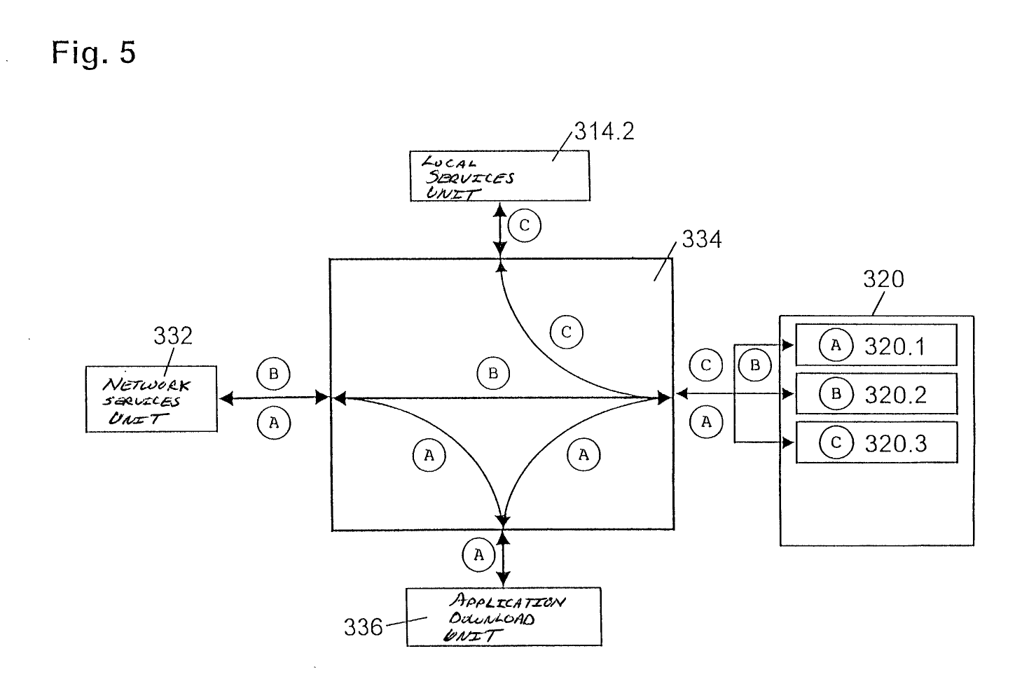

Referring to FIG. 3, the server 1 autonomously initiates a firmware update of the navigation unit 320.1 by transmitting special messages to the application download unit 336 via the network services unit 332 and the firewall 334 in the communication manager 330. The firewall 334 checks the data and discards them if necessary. The data flow of this example is identified in FIG. 5 with the reference symbol A.

In contrast, the prior art data transmission system of FIG. 1 cannot autonomously perform such a firmware update, since the firewall 334a will not permit this. The prior art data transmission system illustrated in FIG. 2 can autonomously initiate and implement a firmware update of the navigation unit, but there is no data check. As a result, data transfer secured against unauthorized access is not guaranteed.

### EXAMPLE #2

### Retrieving an Internet Page from the Server

Referring to FIG. 3, in the browser client 312, the user retrieves a page from the Internet (server 1), and immediately sees this displayed directly on the display unit 310.1. If merely a retrieval and display of information are involved, the communication takes place in the standardized region between the browser client 312 and the server 1 (i.e., there is not data transfer via the firewall 334). In principle, any arbitrary Internet page can be retrieved and displayed. Which pages are displayed depends on the browser client 312 that is being used.

As soon as vehicle-specific data are to be downloaded and processed further (e.g., the transfer of position data to the navigation unit 320.1) these data are checked by the firewall 334 of the communication manager 330, and subsequently are either forwarded or discarded. If the data are forwarded, data flow takes place through the firewall 334. This data flow is identified in FIG. by the reference symbol B.

In contrast, in the prior art system illustrated in FIG. 1, an Internet page can be retrieved, but the incoming data are always checked for security-specific aspects. A direct connection is not possible and data traffic is inhibited. If truly security-relevant data are transmitted, this constant checking is appropriate. Otherwise, a troublesome delay occurs.

In the prior art system illustrated in FIG. 2, it is always possible to retrieve an Internet page since there is no firewall, and as a result, unhindered data traffic takes place. Even security-relevant data are not checked.

### EXAMPLE #3

### Telematic Application

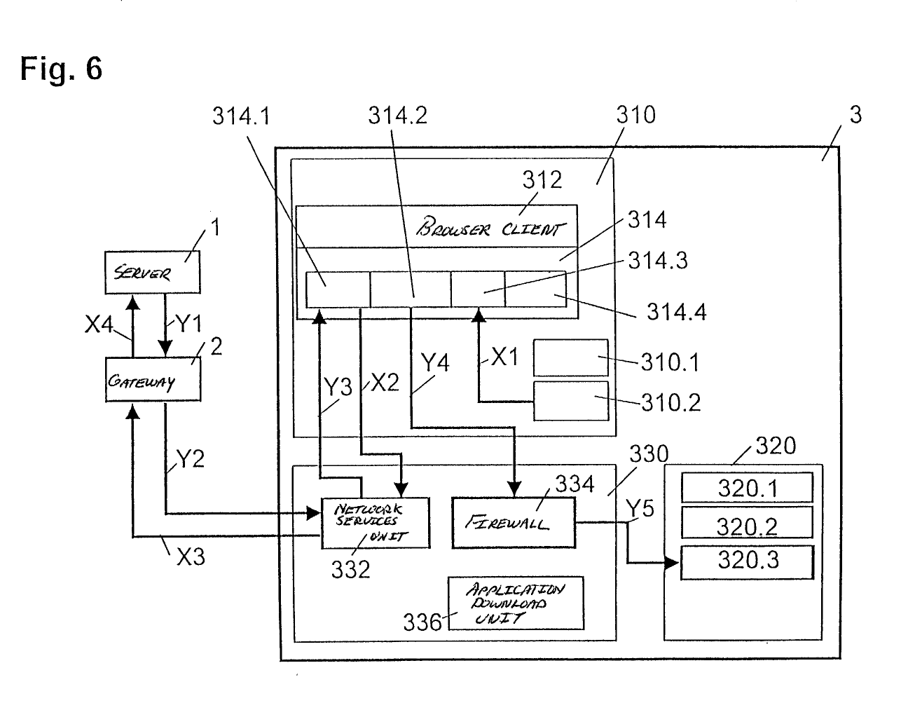

There are special methods for transmitting telematic data to the motor vehicle. For example, these data can be traffic information, traffic-jam information, or accident information. These are transmitted directly from a server to the navigation unit. The data are generally retrieved by the operator via the operating unit 314.3 or the input unit 310.2, the network access 314.1, the network services unit 332, the gateway 2 to the server 1. This request data stream (i.e., the route of the data request) is identified in FIG. 6 with the reference symbols X1, X2, X3, and X4.

The data are then transmitted from the server 1 via the gateway 2 to the network services unit 332, and from there further via the network access 314.1, the local services unit 314.2, the firewall 334, to the telematic application 320.3. The route of data transmission is identified in FIG. 6 by the reference symbols Y1, Y2, Y3, Y4, and Y5.

The data flow in the firewall 304 is shown by the arrows with the reference symbols C in FIG. 5.

### EXAMPLE #4

### Reception of an Audio Signal Via WAP

The user of the vehicle, for example, retrieves an Internet page that offers audio data. The user chooses an audio file, which subsequently is transmitted to the audio unit 320.2. The audio unit then plays this audio data stream.

For the data transfer in the systems according to FIGS. 1 and 2, the discussions regarding the exemplary scenarios 1 and 2 apply analogously.

Although the present invention has been shown and described with respect to several preferred embodiments thereof, various changes, omissions and additions to the form and detail thereof, may be made therein, without departing from the spirit and scope of the invention.

What is claimed is:

1. A client automobile computing system that communicates over a wireless communication channel with a server, said client automobile computing system comprising:
a main unit that includes (i) a browser client component, (ii) a plurality of functional units including a local services unit that each service said browser client, (iii) a display unit and (iv) an input unit;
a communications manager component that includes
(i) a network services unit that receives data from the server and transmits data to the server;
(ii) an application download unit;
(iii) a firewall positioned between said network services unit and said application download unit; and
a plurality of electronic devices including a navigation unit and an audio unit that receive data from and send data to said firewall, wherein
said firewall permits data flow between: (i) said local services unit and said navigation unit and said audio unit, (ii) said application download unit and said navigation unit and said audio unit (iii) said application download unit and said network services unit, and (iv) said network services unit and said navigation unit and said audio unit.
